(19) United States
(12) Patent Application Publication
(10) Pub. No.: US 2019/0030466 A1
(43) Pub. Date: Jan. 31, 2019

(54) Fluid filter comprising a housing and a central vertical pipe that forms a fluid outlet

(71) Applicant: Hengst SE, Muenster (DE)

(72) Inventor: Wilhelm ARDES, Ascheberg (DE)

(73) Assignee: HENGST SE, Münster (DE)

(21) Appl. No.: 15/755,795

(22) PCT Filed: Aug. 23, 2016
(86) PCT No.: PCT/EP2016/069899

§ 371 Date: Feb. 27, 2018

(30) Foreign Application Priority Data
Aug. 28, 2015 (DE) 102015114320.8

(51) Int. Cl. B01D 29/15; B01D 35/147; B01D 35/153

(52) U.S. Cl. CPC B01D 29/15; B01D 35/147; B01D 2201/4092; B01D 2201/316; B01D 35/153

(57) ABSTRACT

A fluid filter comprising a housing with a fluid inlet and a fluid outlet, a central vertical pipe that forms the fluid outlet, a filter cartridge pushed onto the vertical pipe, and a valve unit. The vertical pipe has a screw thread on each axial end region for connection into the housing on one side and to a filter connection flange on the other side, and at least one passage in the region lying between the end regions. In one aspect, the vertical pipe has, on the outer periphery of the region lying between the axial end regions, guide elements for at least one valve body of the valve unit and/or guide elements and retaining elements for a valve spring support of the valve unit.

### CROSS-REFERENCES TO RELATED APPLICATIONS

This application claims the benefit of the German patent application No. 10 2015 114 320.8 filed on Aug. 28, 2015, the entire disclosures of which are incorporated herein by way of reference.

### BACKGROUND OF THE INVENTION

The present invention relates to a fluid filter having a housing having a fluid inlet and a fluid outlet, having a central vertical pipe that forms the fluid outlet, having a filter insert that is plugged onto the vertical pipe, and having a valve unit, the vertical pipe having a screw threading on each of its axial end regions for connection at one side to the housing and at the other side to a filter connecting flange, and having at least one through-opening in its region situated between the end regions.

A fluid filter of the type described above is known for example from WO 2015/036107 A1. Based on this existing art, an object arises of providing fluid filters of the type described above that enable an integration of additional properties and functions in the central vertical pipe in order to increase the functionality of the fluid filter while keeping its production low in cost.

### SUMMARY OF THE INVENTION

A first solution of the object is achieved according to the present invention by a fluid filter of the type described above that is characterized in that the vertical pipe has, in its region situated between the axial end regions, guide elements on its outer periphery for at least one valve body of the valve unit, and/or guide elements and retaining elements for a valve spring support of the valve unit.

In this fluid filter, in addition to its function as fluid outlet, the vertical pipe additionally has the function of guiding and/or retaining further components of the fluid filter situated on the outer periphery of the vertical pipe.

In addition, in the fluid filter the vertical pipe can have, in its region between the axial end regions, additional guide elements on its outer periphery for a valve spring of the valve unit.

For reasons of low-cost production of the fluid filter and high stability of the vertical pipe, the elements described above are preferably ribs or webs integrally formed in one piece on the vertical pipe.

According to the present invention, a second solution of the object described above is achieved by a fluid filter of the type described above that is characterized in that the valve unit is or has a filter bypass valve, and that a valve plate having at least one through-opening of the filter bypass valve is situated in the region of the vertical pipe situated between the axial end regions, on the outer periphery of the pipe, and that the vertical pipe has a sealed configuration of a plurality of through-openings in its region situated between the axial end regions, at an outflow side of the filter bypass valve.

In this fluid filter, the vertical pipe bears the valve plate of a filter bypass valve. In addition, the vertical pipe is made so as to have flow properties that are favorable for the filter bypass valve.

In a further embodiment of the second fluid filter according to the present invention, it is preferably provided that the vertical pipe has, at the height of the valve plate, a peripheral sealing surface on its outer periphery that works together in sealing fashion with a sealing contour on a radially inner periphery of the valve plate. In this way, a required tight connection of the valve plate and vertical pipe is brought about in a technically simple manner.

A third solution of the object of the invention is achieved by a fluid filter of the type described above that is characterized in that the vertical pipe has an axial support collar on its outer periphery at the axially inner end of the one screw threading or of the other screw threading or of both screw threadings. By means of the support collar or collars, a defined end position is ensured of the screw connection or screw connections at one or both ends of the vertical pipe when the pipe is connected to further parts of the fluid filter and/or to the connecting flange.

For all fluid filters according to the present invention described above, it is preferably further provided that the central vertical pipe is made with a screwdriver tool attachment at its end remote from the filter connecting flange. This creates the possibility of using a fitting screwdriver tool on the vertical pipe in order to screw the vertical pipe to the connecting flange and thus to enable the production of sufficiently large torques without damaging the vertical pipe. Here, the vertical pipe is of course realized in its structure and dimensions in such a way that it can accept and communicate the necessary torques and torsion forces exerted by the screwdriver tool without damage.

A further solution of the object of the invention is achieved by a fluid filter of the type described above that is characterized in that the central vertical pipe is realized with a screwdriver tool attachment at its end remote from the filter connecting flange.

In this fluid filter, in addition to its function as fluid outlet, the vertical pipe has only the additional function of providing a screwdriver tool receptacle that can serve usefully during assembly and disassembly of the fluid filter.

The screwdriver tool receptacle can, for example, be an outer or inner hexagon or a Torx receptacle or some other suitable receptacle, preferably fashioned to accept currently standard tools.

In all fluid filters according to the present invention indicated above, the central vertical pipe is preferably a one-piece injection molded part made of a standard plastic or of a high-performance plastic. Here, the choice of plastic is determined, in particular, according to the pressure and/or temperature stresses, or possibly chemical stresses, that occur during operation of the fluid filter.

Alternatively, the central vertical pipe can be a component made of aluminum or zinc or steel, so that the vertical pipe can withstand particularly high mechanical and thermal stresses.

The threading on the central vertical pipe can be a metric threading or, if the vertical pipe is made of plastic, can be a threading suitable for plastic, e.g. S20×1.5; bayonet connections can also be provided.

In order to save weight and material, the vertical pipe usefully has cross-sections between its two end threadings that are optimized with regard to strength, only as much material being used in the various zones of the vertical pipe as is required for the secure acceptance of the occurrent axial tensile forces and torsion forces.

### BRIEF DESCRIPTION OF THE DRAWINGS

In the following, exemplary embodiments of the present invention are explained on the basis of the drawing.

FIG. 1 shows a fluid filter having a central vertical pipe in a first embodiment, in longitudinal section;

FIG. 2 shows the vertical pipe of the fluid filter of FIG. 1 as an individual part, in a side view;

FIG. 3 shows the vertical pipe in a modified embodiment, as an individual part, in a side view;

FIG. 4 shows a second fluid filter having a vertical pipe according to FIG. 3, in longitudinal section; and

FIG. 5 shows the vertical pipe in a modified embodiment, as an individual part, in longitudinal section.

### DETAILED DESCRIPTION OF THE PREFERRED EMBODIMENTS

In the following description of the Figures, identical parts in the various drawings are always provided with the same reference characters, so that all reference characters do not have to be explained again for each drawing.

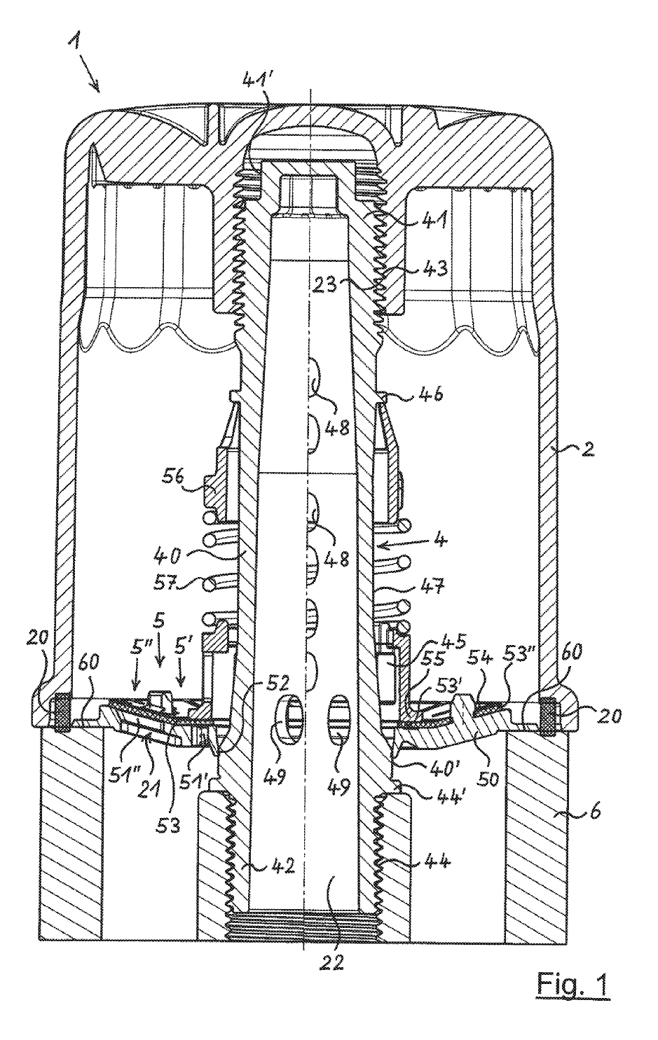

FIG. 1 shows a fluid filter 1 having a central vertical pipe 4 in a first embodiment in longitudinal section. Fluid filter 1 has a cup-shaped housing 2 that is downwardly open, having, at the top in its interior, a central inner threading 23 that is screwed together with an outer threading 43 in upper end region 41 of central vertical pipe 4.

Via an outer threading 44 on lower end region 42 of central vertical pipe 4, fluid filter 1 is screwed to a connecting flange 6, here specifically to a threaded support having an inner threading, for example on an internal combustion engine; here, an axial support collar 44′ on the upper end of threading 44 limits the screw-in depth to a particular extent.

On the axially outer end of its upper end region 41, central vertical pipe 4 has, externally, a screwdriver tool attachment 41′ in the form of an outer hexagon, in order to make it possible to apply a fitting screwdriver tool to central vertical pipe 4 when central vertical pipe 4 is screwed to connecting flange 6.

In addition, fluid filter 1 shown in FIG. 1 has a valve unit 5 that includes a filter bypass valve 5′ and a non-return valve 5″. The bearing part of valve unit 5 is a valve plate 50 that is essentially formed as a circular annular plate, and that has on its radially inner edge a sealing contour 54 that interacts in sealing fashion with a sealing surface 40′ on the outer periphery of central vertical pipe 4, a short distance above lower threading 44. Filter bypass valve 5′ includes a valve body 55 that is guided in axially displaceable fashion on guide elements 45 on the outer periphery of vertical pipe 4. Above valve body 55, there is situated a valve spring 57 that is guided on a region of the outer periphery of vertical pipe 4 that forms a guide element 47. The upper end of valve spring 57 is supported on a valve spring support 56 that is also situated on the outer periphery of central vertical pipe 4, fixed in the axial direction by guide and retaining elements 46.

Non-return valve 5″ is situated radially external to filter bypass valve 5′. The two valves 5′ and 5″ additionally have in common a valve membrane 53 that is situated on valve plate 50. Through valve plate 50 there run, radially inwardly, through-openings 51′ for filter bypass valve 5′ and, radially outwardly, through-openings 51″ for non-return valve 5″, the fluid inlet 21 running to the interior of housing 2 through the through-openings 51″. On the upper side of valve membrane 53 there is situated a spring plate 54 that pre-loads valve membrane 53 in its radially external region 53″ with a force acting in the closing direction of non-return valve 5″. In its radially inner region 53′, valve membrane 53 works together with valve body 55 of filter bypass valve 5′.

At a distance above valve unit 5, situated at a distance from one another in the axial direction, a plurality of through-openings 48 are provided in central vertical pipe 4, which openings permit passage of fluid filtered in fluid filter 1. A filter insert having a known design, situated inside fluid filter 1 during operation, is not shown here for clarity. At the height of valve unit 5, a plurality of through-openings 49 are situated at the same height in vertical pipe 4, at a distance from one another in the peripheral direction, in order to ensure a low-resistance outflow of fluid bypassing the filter insert when filter bypass valve 5′ is open.

In its state shown in FIG. 1, installed on a connecting flange 6, fluid filter 1 is sealed against a peripheral sealing surface 60 of connecting flange 6 by a peripheral annular seal 20 situated on the lower, free end of housing 2.

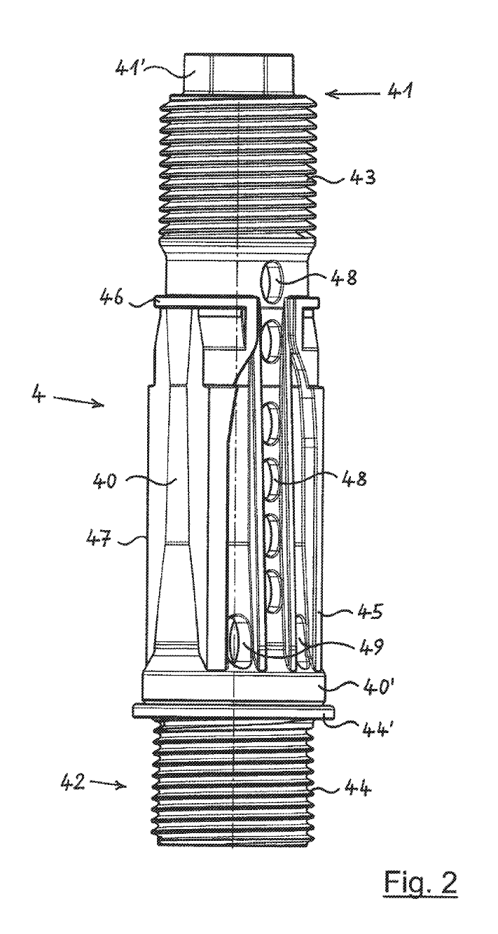

FIG. 2 shows vertical pipe 4 of fluid filter 1 of FIG. 2 as an individual part in a side view. At the end face of upper end region 41 of vertical pipe 4, its screwdriver tool attachment 41′ is visible. Under it there is situated upper threading 43 of vertical pipe 4, realized as an outer threading.

On lower end region 42 of vertical pipe 4 there is situated lower threading 44, which is also an outer threading. Threading 44 is upwardly limited by axial support collar 44′. Above support collar 44′, on the outer periphery of vertical pipe 4 there is situated sealing surface 40′, which in the assembled state works together with valve plate 50.

In region 40 situated between axial end regions 41, 42, vertical pipe 4 has first through-openings 48. In its region situated a short distance above sealing surface 40′, in vertical pipe 4 there are situated second through-openings 49, which are allocated to filter bypass valve 5′.

Guide elements 45 for valve body 55, guide and retaining elements 46 for valve spring support 56, and guide elements 47 for valve spring 57 are fashioned in the form of outwardly protruding ribs or webs on the outer periphery of region 40 of vertical pipe 4, made in one piece with the rest of vertical pipe 4.

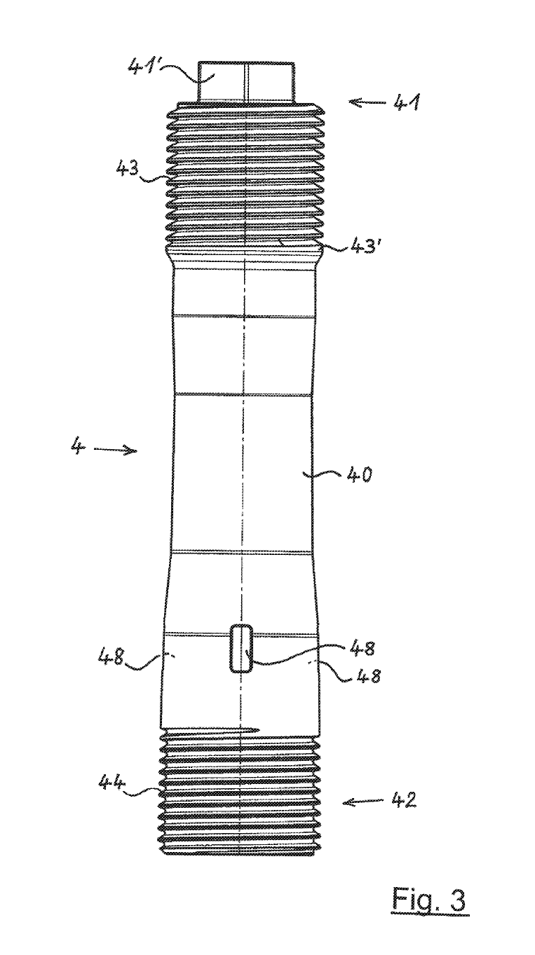

FIG. 3 shows vertical pipe 4 in a modified, simplified embodiment, again as an individual part, in a side view. On the end face of its upper end region 41, vertical pipe 4 has a screwdriver tool attachment 41′, here as well in the form of an outer hexagon. Below screwdriver tool attachment 41′ there is situated upper threading 43, which is downwardly limited by an axial support collar 43′.

Lower threading 44 is integrally formed at the very bottom on lower end region 42 of vertical pipe 4. Above threading 44, a plurality of through-openings 48 are made in vertical pipe 4, distributed in its peripheral direction, which openings lead to the fluid outlet (not shown here) that runs through the interior of vertical pipe 4.

Region 40 of vertical pipe 4 between its axial end regions 41, 42 is here made with a smooth surface and without special elements, and its outer diameter varies only slightly over its axial length.

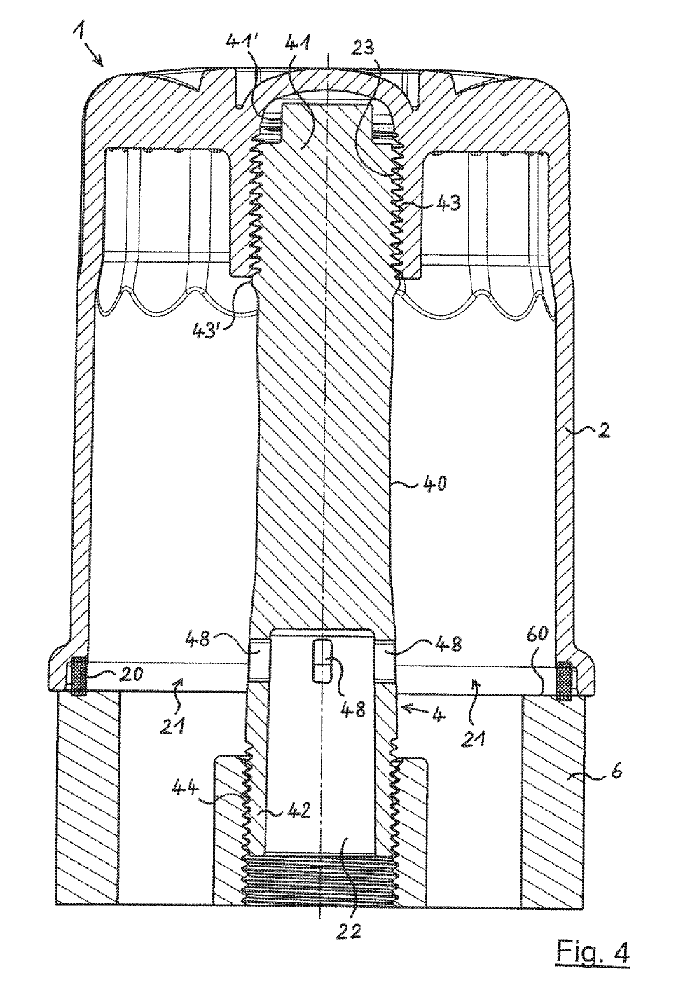

FIG. 4 shows a second fluid filter 1 having a vertical pipe 4 according to FIG. 3, in longitudinal section; here as well, the filter insert which is, of course, present during operation of fluid filter 1 is not shown for reasons of clarity.

Fluid filter 1 here likewise has a cup-shaped housing 2 that is screwed together with upper threading 43 of vertical pipe 40 by means of an inner threading 23 situated in the interior of housing 2. The screw-in depth of this screw connection is limited by axial support collar 43′ on the lower end of threading 43.

With threading 44 in its lower end region 42, vertical pipe 40 is screwed to a central pipe socket having an inner threading of connecting flange 6. Here as well, an annular peripheral seal 20 is used to seal housing 2 against a peripheral sealing surface 60 of connecting flange 6.

At the height of seal 20, and somewhat above it, through-openings 48 are formed in vertical pipe 4, through which openings filtered fluid flows to fluid outlet 22 during operation of fluid filter 1.

As FIG. 4 shows, central vertical pipe 4 does not have to be made hollow over its entire axial length; as is shown as an example in FIG. 4, it is also possible for only the lower part of vertical pipe 4 to be pipe-shaped, going downward from through-openings 48. However, for reasons of weight, in practice a central vertical pipe 4 is preferable that is hollow over approximately its entire length and is sealed only at the upper side.

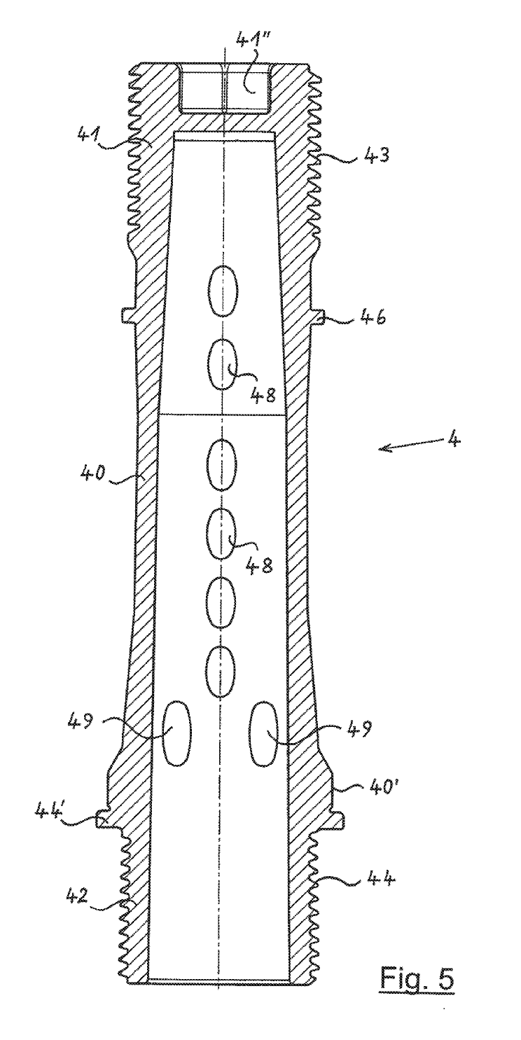

FIG. 5 shows vertical pipe 4 in a modified embodiment, as an individual part, in longitudinal section. Characteristic for this embodiment of vertical pipe 4 is that here a screwdriver tool socket 41″ is provided in the form of an inner hexagon in upper end region 41 of vertical pipe 4. In this way, without reducing the axial length of upper threading 43 of vertical pipe 4, a shorter overall axial length of vertical pipe 4 is achieved, which advantageously reduces the required installation space.

With regard to the further parts in FIG. 5, reference is made to the preceding description of FIGS. 1 through 4.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### LIST OF REFERENCE CHARACTERS

1 fluid filter
2 housing
20 seal
21 fluid inlet
22 fluid outlet
23 threading in 2
4 central vertical pipe
40 region between ends
40′ sealing surface for 52
41 first axial end region of 4 (top)
41′ screwdriver tool attachment
41″ screwdriver tool socket
42 second axial end region of 4 (bottom)
43 threading on 41
43′ axial support collar on 43
44 threading on 42
44′ axial support collar on 44
45 guide elements for 55
46 guide and retaining elements for 56
47 guide elements for 57
48 through-opening(s)
49 through-openings in 5′
5 valve unit
5′ filter bypass valve
5″ non-return valve
50 valve plate
51′ through-openings of 5′ in 50
51″ through-openings of 5″ in 50
52 sealing contour radially inward on 50
53 valve membrane
53′ radially inner region of 53
53″ radially outer region of 53
54 spring plate
55 valve body
56 valve spring support
57 valve spring
6 connecting flange
60 sealing surface

1-10. (canceled)

11. A fluid filter comprising:
a housing having a fluid inlet and a fluid outlet,
a central vertical pipe forming the fluid outlet,
a filter insert plugged onto the vertical pipe, and
a valve unit,
the vertical pipe having, on each axial end region, a screw threading for connection at one side to the housing and at the other side to a filter connecting flange, and at least one through-opening in a region situated between the end regions,
wherein the vertical pipe has, on an outer periphery in a region situated between the axial end regions, at least one of
guide elements for at least one valve body of the valve unit, or
guide and retaining elements for a valve spring support of the valve unit.

12. The fluid filter as recited in claim 11, wherein the vertical pipe additionally has on an outer periphery, in the region situated between the axial end regions, guide elements for a valve spring of the valve unit.

13. The fluid filter as recited in claim 11, wherein the guide elements or guide and retaining elements are ribs or webs integrally formed in one piece on the vertical pipe.

14. The fluid filter as recited in one of claim 11, wherein the central vertical pipe is realized having a screwdriver tool attachment/socket on an end region remote from the filter connecting flange.

15. The fluid filter as recited in claim 11, wherein the central vertical pipe is a one-piece injection molded part made of a standard plastic or of a high-performance plastic.

16. The fluid filter as recited in claim 11, wherein the central vertical pipe is a component made of aluminum or zinc or steel.

17. A fluid filter comprising:
a housing having a fluid inlet and a fluid outlet,
a central vertical pipe forming the fluid outlet,
a filter insert plugged onto the vertical pipe, and
a valve unit,
the vertical pipe having, on each axial end region, a screw threading for connection at one side to the housing and at the other side to a filter connecting flange, and at least one through-opening in a region situated between the end regions,
wherein the valve unit is or includes a filter bypass valve,
wherein a valve plate having at least one through-opening of the filter bypass valve is situated in a region of the vertical pipe situated between the axial end regions, on the outer periphery of the pipe, and
wherein the vertical pipe has a sealed configuration of a plurality of through-openings in a region situated between the axial end regions, at an outflow side of the filter bypass valve.

18. The fluid filter as recited in claim 17, wherein the vertical pipe has, at the height of the valve plate, a peripheral sealing surface on an outer periphery, which surface interacts in sealing fashion with a sealing contour on a radially inner periphery of the valve plate.

19. The fluid filter as recited in claim 17, wherein the central vertical pipe is realized having a screwdriver tool attachment/socket on an end region remote from the filter connecting flange.

20. The fluid filter as recited in claim 17, wherein the central vertical pipe is a one-piece injection molded part made of a standard plastic or of a high-performance plastic.

21. The fluid filter as recited in claim 17, wherein the central vertical pipe is a component made of aluminum or zinc or steel.

22. A fluid filter comprising:
a housing having a fluid inlet and a fluid outlet,
a central vertical pipe forming the fluid outlet,
a filter insert plugged onto the vertical pipe and
a valve unit,
the vertical pipe having on each axial end region a screw threading for connection at one side to the housing and at the other side to a filter connecting flange, and having at least one through-opening in a region situated between the end regions,
the vertical pipe having, on an outer periphery, an axial support collar on an axially inner end of the one screw threading or of the other screw threading or both screw threadings.

23. The fluid filter as recited in one of claim 22, wherein the central vertical pipe is realized having a screwdriver tool attachment/socket on an end region remote from the filter connecting flange.

24. The fluid filter as recited in claim 22, wherein the central vertical pipe is a one-piece injection molded part made of a standard plastic or of a high-performance plastic.

25. The fluid filter as recited in claim 22, wherein the central vertical pipe is a component made of aluminum or zinc or steel.

26. A fluid filter comprising:
a housing having a fluid inlet and a fluid outlet,
a central vertical pipe forming the fluid outlet,
a filter insert plugged onto the vertical pipe, and
a valve unit,
the vertical pipe having on each axial end region a screw threading for connection at one side to the housing and at the other side to a filter connecting flange, and at least one through-opening in a region situated between the end regions, and
the central vertical pipe having a screwdriver tool attachment/socket on an end region remote from the filter connecting flange.

27. The fluid filter as recited in claim 26, wherein the central vertical pipe is a one-piece injection molded part made of a standard plastic or of a high-performance plastic.

28. The fluid filter as recited in claim 26, wherein the central vertical pipe is a component made of aluminum or zinc or steel.
